(19) United States
(12) Patent Application Publication
(10) Pub. No.: US 2012/0084291 A1
(43) Pub. Date: Apr. 5, 2012

(54) APPLYING SEARCH QUERIES TO CONTENT SETS

(75) Inventors: Wook Jin Chung, Kirkland, WA (US); Michael Joseph Papale, Seattle, WA (US); Sergio Mario Diaz-Cuellar, Seattle, WA (US); Colin Clayton Tidd, Redmond, WA (US); Chad Steven Estes, Woodinville, WA (US); Jordan Marchese, Ann Arbor, MI (US)

(73) Assignee: Microsoft Corporation, Redmond, WA (US)

(21) Appl. No.: 12/895,360

(22) Filed: Sep. 30, 2010

(51) Int. Cl. G06F 17/30

(52) U.S. Cl. 707/741; 707/748; 707/E17.084; 707/E17.061

(57) ABSTRACT

Queries applied to content sets (e.g., files in a filesystem) often produce search results including many content items having identifiers that match the keywords of the query. However, many search techniques do not account for the relevance of the matching, e.g., whether the match is predictably relevant to the user, or whether the content item only tangentially matches the query. The techniques presented herein involve indexing the content items in a content index according to various identifiers having an identifier weight indicating the predicted relevance if a token of a query matches the identifier. Candidate content items may then be presented as search results sorted by the aggregated identifier weights of the matching identifiers, thereby promoting highly relevant content items and demoting incidentally matching content items. Additional adjustments may be made (e.g., promoting content items that match a particularly infrequent token or that match a phrase in the query).

### BACKGROUND

Within the field of computing, many scenarios involve a content set comprising one or more content items, such as a set of files in a filesystem, a set of email messages in an email mailbox, and a set of contact records in an address book. Such content items may be identified through many identifiers, such as a name, a location within the content set, a user indicated as an owner or creator of the content item, or one or more topics addressed by the contents of the content item.

Within such content sets, a user may wish to search for a particular content item. A user may therefore provide a query comprising one or more keywords, such as a portion of a filename of a file representing the content item or one or more words that appear in an email message. In order to evaluate such queries, a search algorithm may therefore index respective content items of one or more content item sets according to various keywords associated with the content item, e.g., according to the filenames of files in a filesystem or words appearing in the subject or body of email messages in an email mailbox. A search algorithm may therefore apply the query to the content item sets, e.g., by using the search index to identify content items having the keywords in the filename or in the contents of the message, and may present to the user a set of candidate content items matching the query. The search algorithm may therefore apply the query in an efficient manner and may rapidly return results to the user.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

While the evaluation of a query comprising a set of keywords through the use of a search index that indexes the content items may be efficient, the results returned by such search algorithms may be inadequately selective or helpful. As a first example, it may be difficult to use these techniques to select for a keyword that appears often in the content items. In one such scenario, a user may wish to search for a contact record for an individual with the last name of Plant, but if the user is interested in gardening, a large number of content items may incidentally include the term “plant” and may appear in the search results, thereby obscuring the search result relating to the contact record that is sought by the user. As a second example, it may be difficult to apply some queries to the content items indexed in the search index, such as queries for short words (e.g., a search for a contact record of an individual with the last name Su may turn up a large number of content items featuring the letter combination “Su”) and queries based on the initials of an individual (e.g., a search for users with the initials “C C” may produce a result set featuring a name including the letter “C”).

However, it may be possible to interpret the query based on the implied and inferred intent of the user in formulating the query. Thus, rather than simply applying a rote matching of the terms of a query with any identifiers of the entire content item, content items may be indexed based on the likelihood of a user searching for a particular content item based on a particular field. As a first example, it may be appreciated that a user is more likely to search for a content item based on some identifiers (e.g., metadata fields associated with a user name, a filename, or an email message title) than other identifiers (e.g., a small segment of text in a long document). As a second example, a search using the initials “C C” may be inferred as searching for individuals having a name with these initials, or for documents or other files containing a series of words beginning with these letters (such as “carrot cake”). Accordingly, techniques may be devised to index content items according to the manner whereby a user may choose to search for the content item, and to apply a query while searching for content items based on the inferred intent of the user while formulating the query. Such techniques may therefore present search results, may order the search results, in a manner that is higher relevance to the user based on the inferred intent of the query.

Presented herein are techniques for evaluating a query against a content set, comprising various content items (such as locally stored objects of various types, e.g., files in a filesystem, email messages in an email mailbox, and contact records in an address book), that may more robustly evaluate the query and may present more selective search results that may be more highly tailored to the intended meaning of the query. In accordance with these techniques, content items may be indexed in a context index according to various identifiers (e.g., a filename or portion of a filename of a file; the sender email address, recipient email address, and subject keywords of an email message; and a first name, last name, nickname, full name, and email address of a contact record in an address book), but each identifier may be associated with an identifier weight that indicates the likelihood of a user searching for the content item by using the identifier. When a user enters a query, the tokens of the query may be matched with different identifiers associated with different content items, and the candidate content items (those indexed with identifiers matching the tokens of the query) may be sorted according to the weights of the associated identifiers. Moreover, if the query is entered in a particular search context (e.g., a query entered into an email client), it may be inferred that the user may be devising the query in the search context, and may be choosing the terms of the query based on identifiers associated with the search context. Therefore, the identifiers that are associated with the search context (e.g., a Sender field or a Subject field that is more heavily associated with email messages) may be weighted more heavily in computing the rank scores, increasing the likelihood that the retrieved content items may be more relevant to the user due to the search context wherein the user entered the query.

For example, a user entering the query “Su” may match a contact having a last name of “Su”, a second contact having the first name “Susan”, a file named “Grocery List” including the term “sugar”, and an email message including the word “surgery” in the subject. Some search algorithms may present all of these content items as search results, possibly sorted by an arbitrary criterion (e.g., alphabetically or by date of creation). However, in accordance with the techniques presented herein, the indicators whereby each content item is indexed are associated with weights indicating the likelihood that a user entering the query “Su” intended to locate the content item. Therefore, the contact with the last name “Su” (which exactly matches the query) may be presented as a first search result, indicating a high predicted likelihood that the user is searching for this content item (in view of the exact match with a frequently searched property of the content item); the contact with the first name “Susan” and the email message including the term “surgery” may be presented as second and third search results, indicating a medium predicted likelihood that the user is searching for these content items (in view of a partial match with infrequently searched properties of these content items); and the file named “Grocery List” and including the term “sugar” may be presented as the last search result, indicating a low predicted likelihood that the user is searching for this content item (in view of the match with an infrequently searched property of the content item). The search results are therefore presented in a more selective manner, based on the predicted intent of the user in providing “Su” as a token of the query.

As further provided herein, additional techniques may be applied that may further improve the selectivity of the search algorithm in identifying the predicted intent of the user while formulating the query. For example, For example, the search context may be considered while evaluating the predicted relevance of various indicators. For example, if the query “Su” is entered in the context of a search for an individual (e.g., a search initiated in relation to the “To:” field of an email message, or within an address book application), it may be inferred that content items matching the query on a name-related field are likely to be of higher predicted relevance (e.g., further weighing the contacts with the last name “Su” and first name “Susan” over other content items). However, if the user initiates the query in the context of a communication content search (e.g., in the context of a search on a message body), the email message including the term “surgery” may be more highly weighted; and if the user initiates the query in the context of a file content search, the “Grocery List” file containing the word “sugar” may be more highly weighted. Thus, the context of the search may be utilized to adjust the weights of the identifiers matching the query, in order to improve the predicted relevance to the user of the selection and ranking of search results.

As another (alternative or additional) technique, the weights of the search terms may be adjusted based on the correspondence with the sequential order of the tokens of the query with the sequential order of matching portions of the identifier (e.g., for a query comprising the tokens “jo st”, preferentially presenting the search result “Joe Stone” over the search result “Steve Jones”); based on the matching of a token with multiple indicators (e.g., for a query comprising the token “an”, preferentially presenting the search result “Ann Anderson” over the search result “Ann Smith”); and based on the complete matching of a token with an identifier (e.g., for a query comprising the token “Michael”, preferentially presenting the search result “Joe Michael” over the search result “Steve Michaelson”). Such heuristics may promote the presentation of search results in an order that is more likely to conform to the intended meaning of the query formulated by the user than an arbitrary sorting of search results (e.g., by alphabetic order or by date of creation). Additionally, such heuristics may be comparatively simple, such that the adjustment may be made in realtime without significantly prolonging the evaluation of the query or delaying the presentation of search results in response thereto.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring a computing environment comprising various content sets comprising one or more content items.

FIG. 2 is an illustration of an exemplary scenario featuring the application of a query submitted by a user to the content items of various content sets.

FIG. 3 is an illustration of an exemplary scenario featuring an indexing of content items of various content sets in accordance with the techniques presented herein.

FIG. 4 is an illustration of an exemplary scenario featuring the application of a query submitted by a user to the content items of various content sets in accordance with the techniques presented herein.

FIG. 5 is a flow chart illustrating an exemplary method of evaluating queries comprising at least one token against at least one content set comprising at least one content item.

FIG. 6 is a component block diagram illustrating an exemplary system for evaluating queries comprising at least one token against at least one content set comprising at least one content item.

FIG. 7 is an illustration of an exemplary computer-readable medium comprising processor-executable instructions configured to embody one or more of the provisions set forth herein.

FIG. 8 is an illustration of an exemplary scenario featuring an indexing of content items in a content index according to various identifiers.

FIG. 9 is an illustration of an exemplary scenario featuring an extraction of tokens from a query for application to a content index.

FIG. 10 is an illustration of an exemplary scenario featuring an adjusting of rank scores of content items based on a plurality of matched identifier portions of an identifier to a token.

FIG. 11 is an illustration of an exemplary scenario featuring an adjusting of rank scores of content items based on a sequential order of tokens to matched identifier portions of an identifier.

FIG. 12 is an illustration of an exemplary scenario featuring a presentation to a user of candidate content items as search results.

FIG. 13 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Within the field of computing, many scenarios involve a content set comprising various content items, such as a filesystem comprising one or more files, an email system comprising one or more email messages, and an address book featuring one or more contact records. These content sets may be stored locally (e.g., on a memory of a device operated by a user), remotely over a local area network (e.g., on a network file server), or remotely over a wide area network (e.g., on various servers connected to the Internet). Each of these content sets may store the content items in a particular manner (e.g., the filesystem may store files in a hierarchical manner; the email mailbox may store email messages in one or more folders; and the address book may store all contact records together as an unorganized set). The items of each content set may also be structured in various ways, featuring various types of metadata that semantically identify the content item (e.g., files in a filesystem may have a name, a location within the hierarchy of the filesystem, a creation date, and a file type; email messages in an email mailbox may have a sender email address, a subject, and a date of delivery; and contact records in an address book may have a full name, a mailing address, and a profile picture). These various properties may serve as identifiers, whereby a user may distinctively identify and reference a particular content item.

Within such scenarios, a user may wish to search for one or more content items that meet particular criteria. For example, a user may wish to search for content items associated with the name of a colleague, such as files created, owned by, or referencing the colleague, email messages exchanged with or discussing the colleague, and one or more contact records for the colleague. Therefore, a user may submit a query, comprising one or more keywords that may be related to the identifiers of the content items that the user seeks. A device operated by the user that has access to the content items may therefore apply the query in various ways to the content items of the content sets, and may generate a result set comprising the candidate content items that have been identified as matching the query provided by the user. For example, upon receiving a particular query comprising a set of keywords from a user, the device of the user may examine all available content sets for content items matching all of the keywords, and may present the matching candidate content items to the user in response to the query.

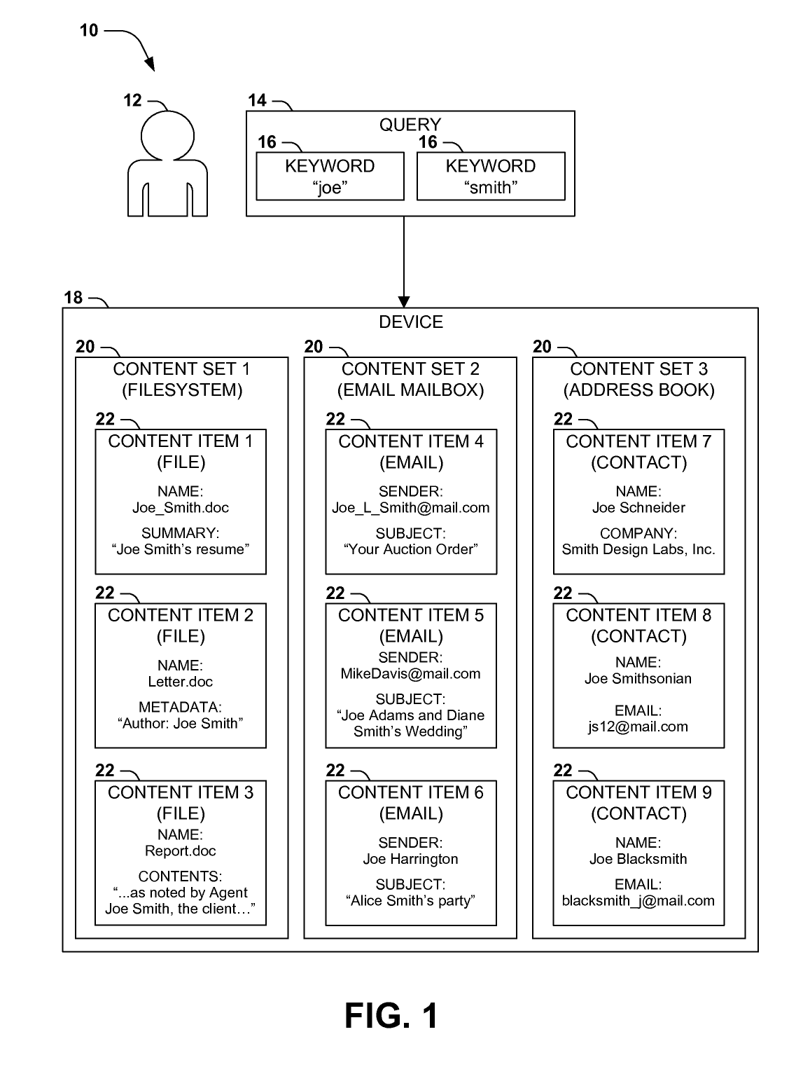

FIG. 1 presents an illustration of an exemplary scenario 10 featuring a user 12 who may submit a query 14 to be applied to various content sets 20 of a computing environment (e.g., a set of user-generated data items stored on a device, such as a computer). The various content sets 20 may comprise one or more content items 22 (e.g., a filesystem storing a set of files, an email mailbox storing a set of email messages, and an address book storing a set of contact records). For example, a device 18 operated by the user 12 may store a set of applications, such as a filesystem explorer, an email messaging client, and an address book application, and each application may store content items 22 of a particular type for use with the application. In this exemplary scenario 10, the user 12 may submit a query 14 specifying a set of one or more keywords 16 (e.g., “joe” and “smith”), and may wish to have the device 18 identify the content items 22 matching the keywords 16 of the query 14. For example, the first content set 20 representing the filesystem may include a first file named “Joe_Smith.doc”; a second file with the name “Joe Smith” included as a metadata field for the author of the document; and a third file comprising a document including the words “Joe Smith”. The second content set 20 representing the email mailbox may store a first email message sent from the email address “Joe_L_Smith@mail.com”; a second email message featuring the subject “Joe Adams and Diane Smith's Wedding”; and a third email message sent from an individual named Joe Harrington and featuring the subject “Alice Smith's party”. The third content set 20 representing the address book may store a first contact record for an individual named Joe Schneider from a company called Smith Design Labs, Inc.; a second contact record for an individual named Joe Smithsonian; and a third contact record for an individual named Joe Blacksmith. All of these content items 22 may match the keywords 16 of the query 14, and the device 18 may therefore present all of these content items 22 as a result set in response to the query 14.

In many such scenarios, the number of content items 22 stored in the content sets 20 against which a user 12 may submit a query 14 may be large. Performing a thorough ad hoc search of each content item 22 in a content set 20 may therefore be very time-consuming, resulting in a significant delay in providing the result set of candidate content items to the user 12 in response to the query 14. Therefore, many devices 18 and content sets 20 are configured to generate, maintain, and utilize a search index, representing an index of the identifiers of each content item 22 in a rapidly searchable data structure (e.g., a hashtable). When the device 18 receives a new content item 22 or an update to a content item 22, the device 18 may examine the content item 22 for identifiers associated with the content item 22 that might subsequently be entered as keywords 16 in a query 14, and may index the content item 22 in the search index according to the identifiers. When the device 18 later receives a query 14 from a user 12, the device 18 may refer to the index to identify the content items 22 associated with each keyword 16 of the query 14, and may rapidly identify and present to the user 12 the candidate content items for the query 14.

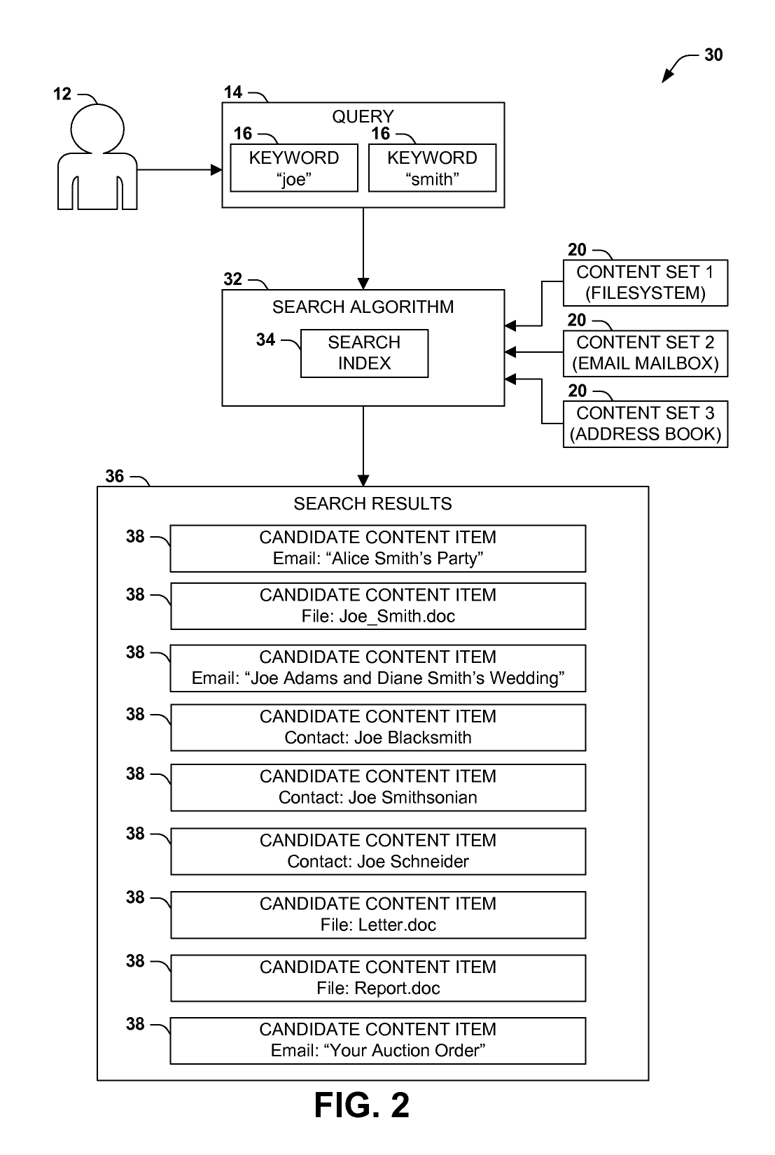

FIG. 2 presents an illustration of an exemplary scenario 30 featuring the indexing of content items 20 and the fulfillment of a query 14. In this exemplary scenario 30, the user 12 again submits a query 14 featuring a set of keywords 16 (e.g., “joe” and “smith”), and a device 18 operated by the user 12 may endeavor to present candidate content items 38 that match the keywords 16 of the query 14. In particular, the device 18 may generate and maintain a search index 34, wherein the content items 22 of the content sets 20 are indexed by various identifiers that may correspond to the keywords 16 of the query 14. The device 18 may also utilize a search algorithm 32 to generate the search index 34 (e.g., a particular algorithm for indexing content items 22 in the search index 34, such as according to a hashcode generated by a particular hash algorithm) and/or use the search index 34 to identify matching content items 22. When the device 18 receives the query 14, the device 18 may apply the search algorithm 32 to the search index 34 to identify the content items 22 matching the keywords 16 of the query, and may generate and present to the user 12 a set of search results 36 comprising the candidate content items 38 matching the query 14. The device 18 may present the candidate content items 38 in an arbitrary order (e.g., the order stored in the search index 34 or identified by the search algorithm 32), or may sort the candidate content items 38 in various ways (e.g., alphabetically, such as illustrated in the exemplary scenario 30 of FIG. 2, and/or grouped based on the content sets 20 of the content items 22. In this manner, the device 18 may fulfill the request of the user 12 to identify content items 22 matching the query 14.

However, while many search algorithms 32 may correctly identify content items 22 matching the keywords 16 of the query 14, the search results 36 may nevertheless be unsatisfying or unhelpful to the user 12. As a first example, if many content items 22 match the query 14, the search results 36 may be voluminous, and it may be difficult for the user 12 to identify and the content items 22 of interest from the candidate content items 38 of the search results 36. As a second example, many content items 22 may incidentally match a particular keyword 16 in ways that the user 12 may not have intended. For example, the user 12 may wish to search for an individual having the last name of “Plant,” and may therefore submit a query 14 including the keyword “plant”. However, if the user 12 is employed as a gardener, many content items 22 (e.g., files and email messages) in the computing environment of the user 12 may include the keyword “plant” and may therefore be identified as candidate content items 38, even if this is not the intended meaning of the term to the user 12. As a third example, the device may be incapable of applying some keywords 16 to the content items 22 of the content sets 20, even with the use of a search index 34. For example, the search index 34 may index content items 22 according to identifiers having a minimum length, e.g., of three alphanumeric characters, because shorter identifiers may match a large number of content items 22. The user 12 may therefore be unable to submit a query 14 for an individual having the last name “Su,” as this keyword 16 may be too short to be evaluated by the search index 34. As a fourth example, the device may not be configured to evaluate particular types of queries, such as queries for individuals having the initials “C C”. In these and other scenarios, the user 12 may be unable to submit a desired query 14, and/or may have difficulty identifying the content items 22 of interest among a large set of candidate content items 38.

It may be appreciated that a significant cause of the inefficiency of comparatively simple techniques for applying a query 14 to one or more content sets 20 relates to the incapability of the evaluation of the relevance of the matched identifiers in a content item 22 to the keywords 16 of a query 14. For example, in the exemplary scenario 30 of FIG. 2, the query 14 of the user 12 specifying the keywords 16 “joe” and “smith” may match the email message from Joe Harrington with the subject “Alice Smith's party,” but the presence of these keywords 16 in this content item 22 may not be significantly relevant. A comparatively simple technique may nevertheless include this content item 22 as a candidate content item 38 in the search results 36, along with many other candidate content items 38 that may be associated with identifiers that logically match the keywords 16 of the query 14, but where such matching may have low relevance to the user 12. As a result, the search results 36 may contain many candidate content items 38 that may logically match the query 14, but that are of comparatively low relevance to the user 12, and the user 12 may have difficulty identifying the candidate content items 38 of interest. Additionally, the high volume of low-relevance candidate content items 38 produced in response to some queries 14, such as those involving the short name “Su” or the initials “C C”, may significantly interfere with the presentation of a relevant search result 36, or may cause the search algorithm 32 to reject such queries 14 from evaluation.

In accordance with this observation, the techniques presented herein are devised to perform an evaluation of a query 14 against content items 22 of various content sets 20 in a manner that also assesses a predicted relevance of the matching of the query 14 to the content items 22. These techniques may be devised to regard the elements of a query 14 not as criteria to be compared with content items 22 in a rote manner, such that every content item 22 matching all criteria in at least a minimal capacity are identified and presented as equally valid search results. Rather, the elements of the query 14 may be regarded as adjectives or “hints” describing the content item(s) 22 that the user 12 wishes to locate. For example, a user may wish to identify content items 22 stored in a computer system relating to a device having particular properties, such as a mobile phone manufactured by a company called “Mobility” and having a 50-centimeter display, a keypad, and of the color black. The user may therefore generate a query 14 comprising the terms “mobility 50 keypad black”. A less sophisticated search algorithm might simply identify every candidate content item 38 matching all four of these tokens in some capacity, and may present the results in an unsorted or arbitrarily sorted manner. However, an embodiment formulated according to the techniques presented herein may endeavor to apply the query according to the implied intent of each element of the query. For example, the number “50” may match at least one aspect of a very large number of candidate items 22, but such matches may have different significance. For example, it may be more likely that the user 12 intended to retrieve a content item 22 describing a phone with a 50-centimeter display or an individual living at 50 Main Street than a document having a file size of 50 kilobytes or a file created 50 days ago. While the latter results may be valid, the former results may have a higher probability of relevance to the intent of the query 14. Accordingly, an embodiment of these techniques may index different content items 22 based not only on a set of identifiers 42, but on different identifier weights 44 of various identifiers 42, indicating the probability that a user 12 searching for the content item 22 may choose to describe or search for it according to that identifier 42. This information may be used to select candidate content items 38 of higher predicted relevance to the user 12, and to adjust the presentation of candidate content items 38 accordingly (e.g., by sorting the candidate content items 38 according to a rank score that is indicative of the identifier weights 44 of the identifiers 42 matching the elements of the query 14).

As one example of the techniques presented herein, among the content items 22 in the exemplary scenario 10 of FIG. 1, it may be observed that some content items 22 may be more relevant matches for the keywords 16 “joe” and “smith” of the query 14 than other content items 22. As a first example, matches with some indicators may be indicative of greater significant than matches with other indicators; e.g., matching the terms “joe smith” with the metadata “Author” field in the second content item 22 may be regarded as of higher predictive relevance than matching the same terms with the contents of the third content item 22. As a second example, the fifth content item 22 features matches with the keywords 16 of the query 14 that are comparatively close (e.g., a few words apart in the “Subject” field of the email message), and may therefore be regarded as of greater predicted relevance than the sixth content item 22, which matches each keyword 16 in a different field (e.g., “joe” matching in the “Sender” field and “Smith” matching in the “Subject” field). As a third example, the eighth content item 22, which matches the keyword “smith” with the beginning of the last name of an individual, may be regarded as of greater predicted relevance than the ninth content item 22, which matches the same keyword with a middle portion of the last name of an individual. In this manner, it may be appreciated that techniques that account for the predicted relevance of the candidate content items 38 with the query 14 may permit the presentation of search results 36 of greater predicted relevance to the query 14 intended by the user 12.

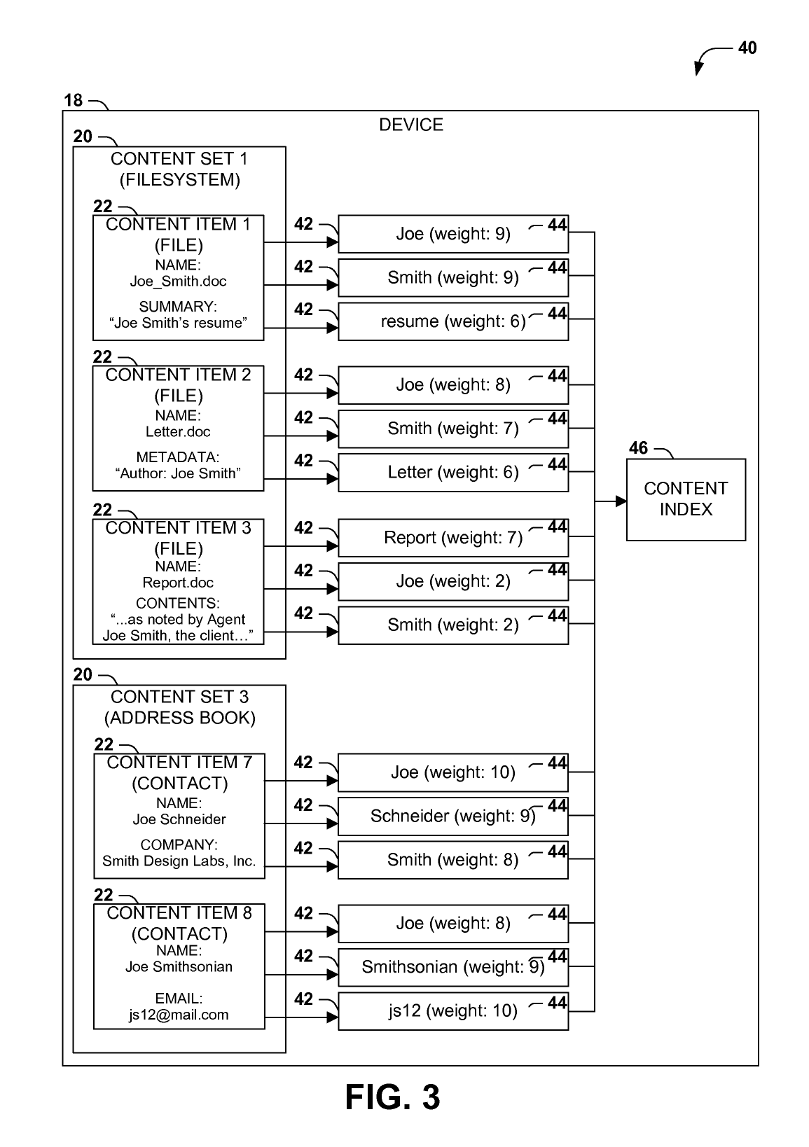

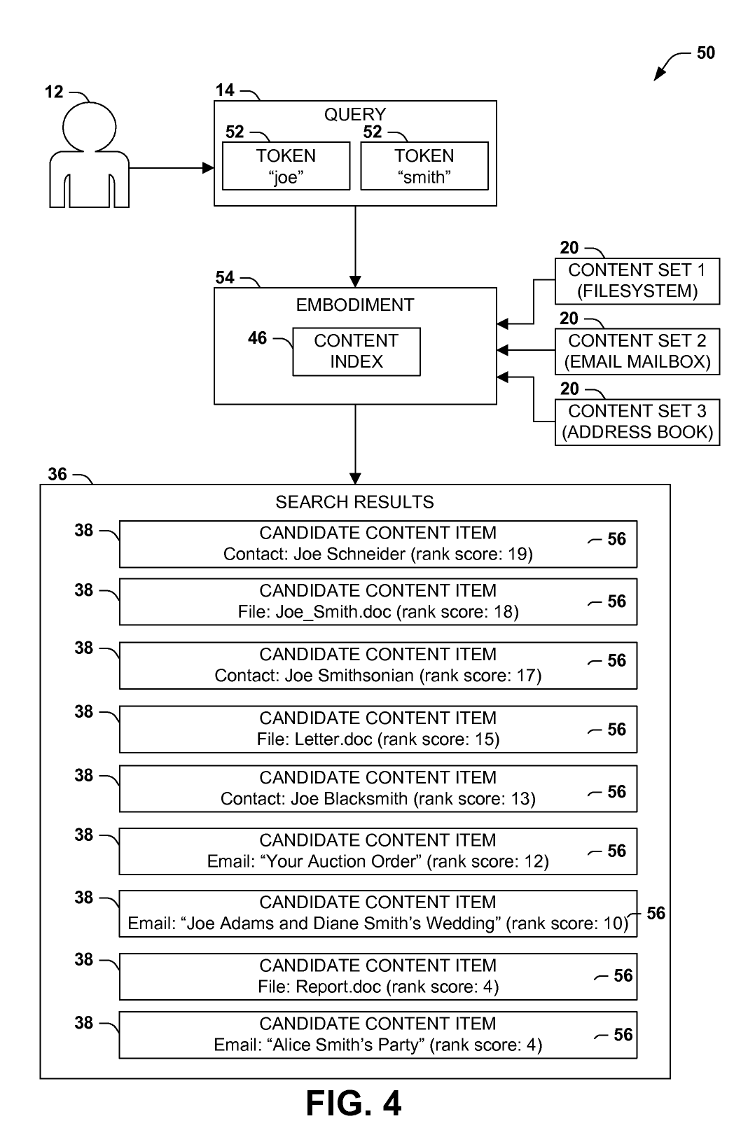

FIGS. 3-4 together present an exemplary scenario featuring the application of these concepts in the formulation of a content index 42, and the use of the content index 42 in presenting to a user 12 search results 36 comprising candidate content items 38 of high predicted relevance to the user 12. FIG. 3 presents an exemplary scenario 40 featuring a device 18 configured to generate a content index 46 that indexes a set of content items 22 in a set of content sets 20 (e.g., files in a filesystem, email messages in an email mailbox, and contact records in an address book) in a manner that promotes relevance-sensitive matching of queries 14 with the indicators of such content items 22. In particular, in this exemplary scenario 40, for each content item 22, several identifiers 42 are selected and indexed in the content index 46 with reference to the content item 22. However, in accordance with the techniques presented herein, each identifier 42 is stored in the content index 46 along with an identifier weight 44, indicating the relevance that may be predicted for the content item 22 to a query 14 specifying the identifier 16. For example, matches with identifiers 42 associated with the first or name of a contact in an address book may be indicative of high relevance, while matches with identifiers 42 associated with a portion of a filename of a file may be regarded as indicative of medium predictive relevance, and matches with identifiers 42 associated with words present in a document may be indicative of low predictive relevance. Identifier weights 44 may be assigned accordingly, e.g., as integers on a scale from one to ten. These identifiers 42 and identifier weights 44 may be stored in the content index 46 associated with the corresponding content items 22 (e.g., the device 18 may, upon receiving a new content item 22 or an update thereto, select identifiers 42 and identifier weights 44 therefore and may store these items in the content index 46). Moreover, different identifiers 42 may be assigned different identifier weights 44 based on differing probabilities that a user 12 may search for a content item 22 according to the identifiers 42. For example, two different individuals represented in an address book named “Joe Schneider” and “Joe Smithsonian,” but the first individual may be a close friend or family member of the user 12 and may therefore be indexed with a higher identifier weight 44 for the first name than the last name. However, the second individual may be a distant acquaintance whom the user 12 may refer to by last name more often than first name, so a higher identifier weight 44 may be associated with the last name than the first name. Similarly, while the identifiers “Joe”, “Smith”, and “Letter” all identify the content item 22 comprising the file named “Letter.doc” and written by an author named “Joe Smith,” the author fields may be considered more likely search terms than a fairly common filename, and may therefore be stored as identifiers 42 with higher identifier weights 44. In this manner, different identifiers 42 may be weighted differently, based on the likelihood that a user 12 may search for the content item 22 using the identifier 42.

FIG. 4 presents an exemplary scenario 50 featuring the use of identifier weights 44 in evaluating a query 14 against the content items 22 of the content sets 20. In this exemplary scenario 50, a user 12 submits a query 14 comprising a set of tokens 54 (e.g., one or more strings of alphanumeric characters separated by whitespace characters, such as spaces, tabs, or carriage returns) that may be matched to the identifiers 42 of the content items 22. An embodiment 54 of these techniques (e.g., a software component executing on a device 18, such as a computer) may refer to the content index 46 generated in the exemplary scenario 40 of FIG. 3 to identify content items 22 that, according to the content index 46, match respective tokens 52 of the query 14. Moreover, in accordance with these techniques, for each candidate content item 38, the embodiment 54 may calculate a rank score 56 based on the identifier weights 44 of the identifiers 42 matching the tokens 52 of the query 14 (e.g., as a sum, a mean arithmetic average, or a median value). The rank scores 56 may indicate the predicted relevance of the candidate content item 38 to the query 14, based on the semantic relationship of the matched identifiers 42 with the tokens 52 of the query 14. The embodiment 54 may then present the candidate content items 38 to the user 12, but may do so based on the rank scores 56, e.g., by sorting the candidate content items 38 in order of descending rank score 56, resulting in the candidate content items 38 having high predicted relevance presented before candidate content items 38 having low predicted relevance. As may be apparent from a comparison of the search results 36 in the exemplary scenario 50 of FIG. 4 (generated in accordance with the techniques presented herein) with the search results 36 in the exemplary scenario 30 of FIG. 2, the embodiment 54 may present search results 36 featuring higher predicted relevance to the user 12.

In some embodiments, additional techniques may be applied to the calculated rank scores 56 in order to enhance the predictions of relevance. In addition to calculating a rank score 56 based on the identifier weights 44 of the identifiers 44 matching the tokens 52 of the query 12, an embodiment may adjust the rank scores 56 based on various properties of the matching. For example, the rank score 56 for a candidate content item 38 may be increased if the identifiers 42 matching respective tokens 52 are sequentially close together; if the same identifier 42 matches several tokens 52; or if a token 52 matches a large part or all of an identifier 42 (e.g., a higher rank score 56 may be attributed to a match of tokens 52 “joe” and “smith” in an exemplary query 14 with the identifier 42 “Joe Smithy” than “Joe Smithkowski,” in view of the greater percentage of the former identifier 42 matched by the token 52). Various adjustment techniques, some of which are presented herein, or combinations thereof may be applied to adjust the rank scores 56 of various candidate content items 38 in order to improve the relevance predictions of the candidate content items 42 with the query 14.

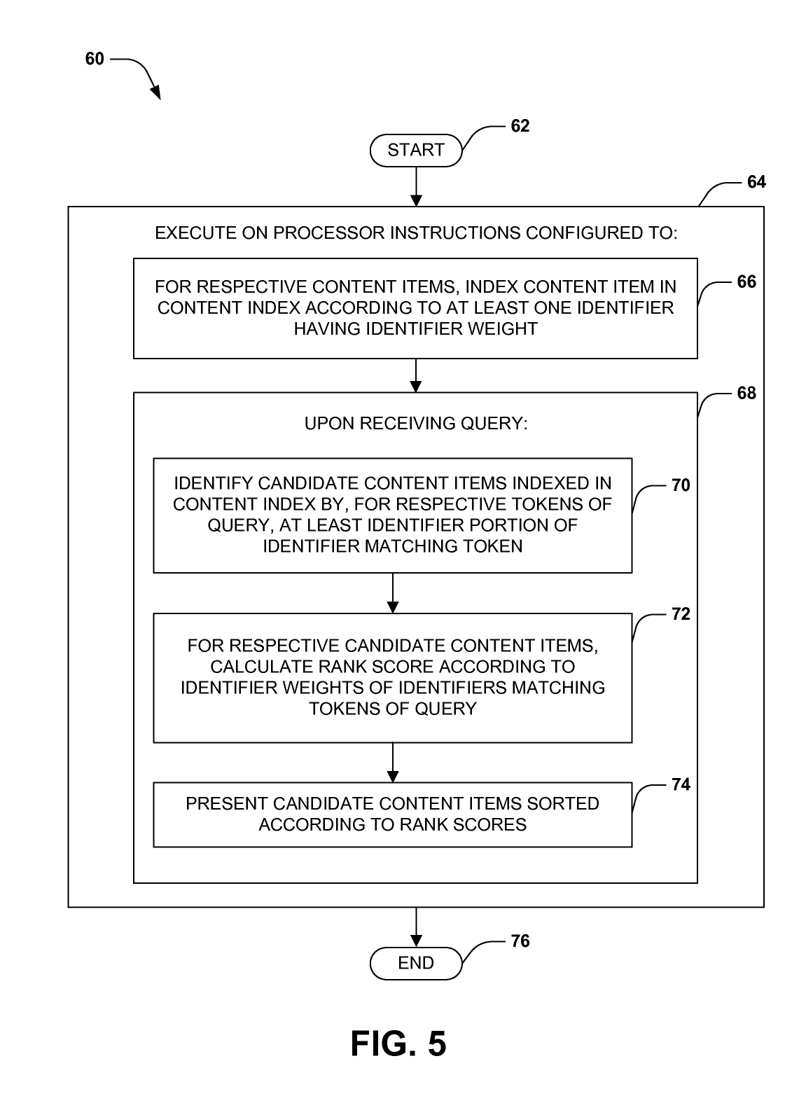

FIG. 5 presents a first embodiment of these techniques, illustrated as an exemplary method 60 of evaluating queries 14 comprising at least one token 52 against at least one content set 20 respectively comprising at least one content item 22, where respective content items 22 have at least one identifier 42. The exemplary method 60 is performed a device 18 having a processor, and may be represented, e.g., as a set of software instructions stored on a volatile or nonvolatile memory component of the device 18, such as system memory, a hard disk drive, a solid-state storage device, or a magnetic optical disc, and that are executable on the processor of the device 18. The device 18 also comprises a content index 46 (e.g., a data structure, such as a hashtable, stored in a memory component of the device 18 and reserved for indexing respective content items 22 according to one or more identifiers 42). The exemplary method 60 begins at 62 and involves executing 64 on the processor instructions configured to present the content items 22 in response to a query 14 in accordance with the techniques presented herein. Specifically, the instructions are configured to, for respective content items 22, index 66 the content item 22 in the content index 46 according to at least one identifier 42 having an identifier weight 56. The instructions are also configured to, upon receiving 68 a query 14, evaluate the query 14 and present search results 36 in the following manner. Upon receiving 68 the query, the instructions are configured to identify 70 candidate content items 38 indexed in the content index 46 by, for respective tokens 52 of the query 14, at least an identifier portion of an identifier 42 matching the token 52. The instructions are also configured to, upon receiving the query 14, for respective candidate content items 38, calculate 72 a rank score 56 according to the identifier weights 44 of the identifiers 42 matching the tokens 52 of the query 14, and present 74 the candidate content items 38 sorted according to the rank scores 56. In this manner, the exemplary method 60 achieves the presentation of candidate content items 38 according to predicted relevance to the query 14 according to the inferred intent of the user 14, and so ends at 76.

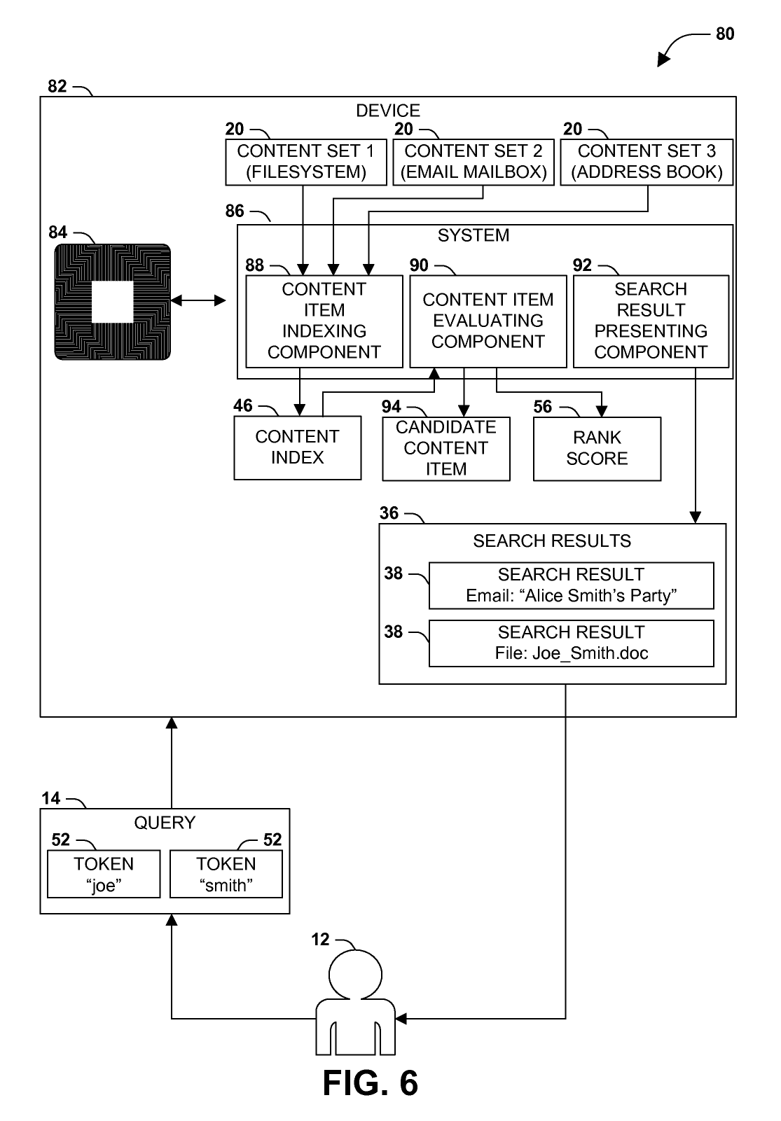

FIG. 6 presents a second embodiment of these techniques, illustrated as an exemplary system 86 configured to evaluate queries 14 comprising at least one token 52 against at least one content set 20 comprising at least one content item 22, where respective content items 22 have at least one identifier 42. The exemplary system may be implemented, e.g., as a software architecture comprising a set of components that interoperate to perform the techniques presented herein, where respective components are implemented as a set of instructions stored in a volatile or nonvolatile memory of a device 82, such as system memory, a hard disk drive, a solid-state storage device, or a magnetic or optical disc. The components of the exemplary system 86 also interact with a content index 46 stored on the device 82 (e.g., a data structure, such as a hashtable, stored in a memory component of the device 82 and reserved for indexing respective content items 22 according to one or more identifiers 42. The exemplary system 86 comprises a content item indexing component 88, which is configured to, for respective content items 22, index the content item 22 in the content index 46 according to at least one identifier 42 having an identifier weight 44. The exemplary system 86 also comprises a content item evaluating component 90, which is configured to, upon receiving a query 14, identify candidate content items 38 indexed in the content index 46 by, for respective tokens 52 of the query 14, at least an identifier portion of an identifier 42 matching the token 52; and, for respective candidate content items 38, calculate a rank score 56 according to the identifier weights 44 of the identifiers 42 matching the tokens 52 of the query 14. The exemplary system 86 also comprises a search result presenting component 92, which is configured to, in response to the query 14, present the candidate content items 38 sorted according to the rank scores 56. In this manner, the components of the exemplary system 86 interoperate to present content items 22 matching a query 14 submitted by a user 12 in accordance with the techniques presented herein.

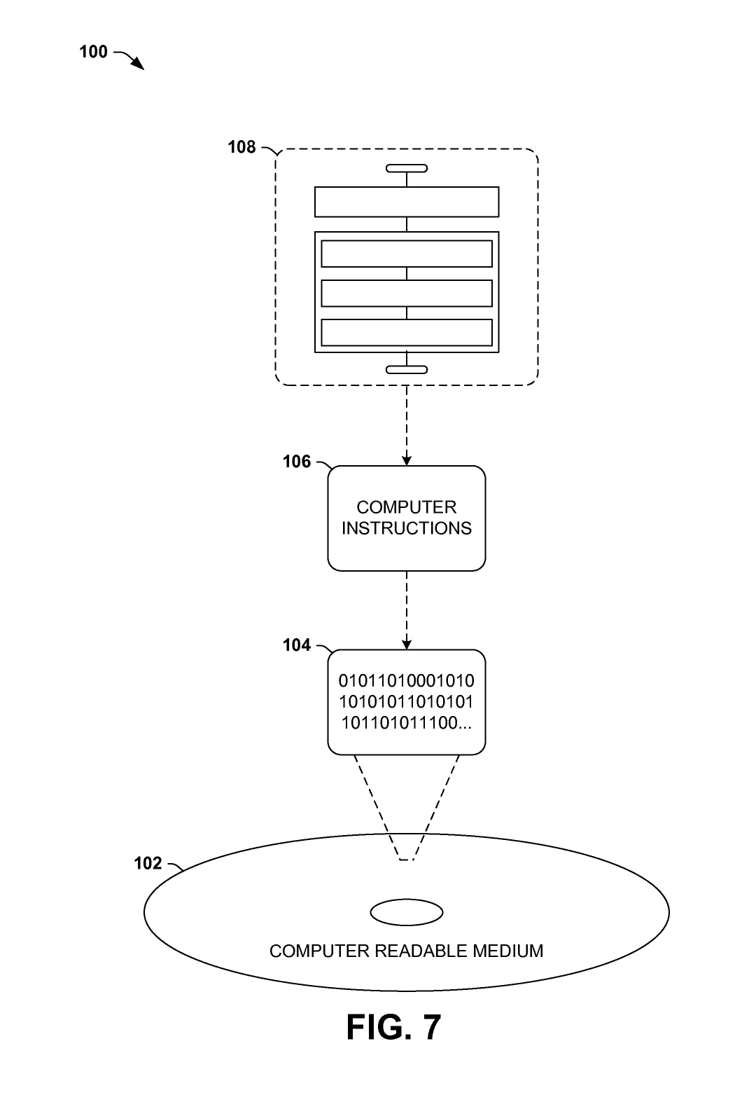

Still another embodiment involves a computer-readable medium comprising processor-executable instructions configured to apply the techniques presented herein. An exemplary computer-readable medium that may be devised in these ways is illustrated in FIG. 7, wherein the implementation 100 comprises a computer-readable medium 102 (e.g., a CD-R, DVD-R, or a platter of a hard disk drive), on which is encoded computer-readable data 104. This computer-readable data 104 in turn comprises a set of computer instructions 106 configured to operate according to the principles set forth herein. In one such embodiment, the processor-executable instructions 106 may be configured to perform a method of evaluating queries comprising at least one token against at least one content set comprising at least one content item, such as the exemplary method 60 of FIG. 5. In another such embodiment, the processor-executable instructions 106 may be configured to implement a system for evaluating queries comprising at least one token against at least one content set comprising at least one content item, such as the exemplary system 86 of FIG. 6. Some embodiments of this computer-readable medium may comprise a non-transitory computer-readable storage medium (e.g., a hard disk drive, an optical disc, or a flash memory device) that is configured to store processor-executable instructions configured in this manner. Many such computer-readable media may be devised by those of ordinary skill in the art that are configured to operate in accordance with the techniques presented herein.

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 60 of FIG. 5 and the exemplary system 86 of FIG. 6) to confer individual and/or synergistic advantages upon such embodiments.

A first aspect that may vary among embodiments of these techniques relates to the scenarios wherein such techniques may be utilized. As a first example, these techniques may be applied to many types of devices 18, including workstations, servers, portable computers such as notebooks, and small devices such as smartphones. As a second example of this first aspect, many types of content sets 20 and content items 22 may be indexed and searched in this manner, including many types of user or system data objects, such as files in a filesystem, email messages in an email mailbox, contacts in a contacts database, objects in an object system, database records in a database, images in an image set, and financial entries in an accounting system. As a third example of this first aspect, many types of queries 12 comprising various types of tokens 52 may be received, such as textual tokens, integer or floating-point tokens, queries structured in a logical manner (e.g., with Boolean connectors), and voice queries comprising tokens 52 translated from spoken phonemes. As a fourth example of this first aspect, the content items 22 may be accessible to the device 18 implementing these techniques in many ways, such as a locally stored content set 20 comprising content items 22 stored in a memory component of the device 18, a network-accessible content set 20 comprising content items 22 accessible over a local area network, or a remote content set 20 comprising content items 22 accessible over a wide area network, such as the Internet.

A particular scenario where the techniques presented herein may be particularly useful involves a content set 20 comprising content items 22 of a content item type. For example, a device 18 may store a set of applications, each of which may manage a custom content set 20 comprising a set of content items 22 of a custom content item type. An embodiment of these techniques (e.g., the exemplary system 86 in the exemplary scenario 80 of FIG. 6) may be configured to allow applications to specify that content items 22 of a custom content item type are to be indexed in the content index 46, and to allow the user 12 to input a query 14 that may search among the content items 22 managed by the application. For example, an application storing a particular type of data may choose to index the content items 22 representing the data in various ways based on how a user 12 may think about searching for the content items 22. In one such scenario, an application comprising an automobile database may include fields comprising structured data about particular vehicles, such as a year, color, and engine type. The application may therefore request that an embodiment of these techniques index the records as content items 22 according to various identifiers 42 matching the respective fields, such as “1957”, “blue”, and “v8”, such that a user entering some or all of these terms into a query may be presented with this record as a candidate content item 38. A user 12 may also narrow this search by explicitly characterizing some or all of the query 14. For example, the record may be indexed according to an identifier such as 42 “vehicle” or “automobile,” and may be retrieved as a candidate content item based on this identifier 42. Alternatively or additionally, some identifiers 42 may be explicitly indexed according to an identifier type (possibly as a key/value pair), such as “vehicle color: blue,” and the query 14 may specify such identifier types, e.g., “vehicle color blue.” This capability may therefore represent a “pluggable” aspect, where custom applications may utilize the search infrastructure of the device 14 to extend to custom content item types.

Additionally, these techniques may be particularly useful in some scenarios due to the rapid evaluation of a query 14 against a set of content items 22. As one example, these techniques may be applied in the context of suggestions of query results while a user 12 continues to enter the query 14. For example, when the user 12 begins entering a first query 14, a first set of candidate content items 38 corresponding to the first query 14 may be identified and presented to the user 12. However, the user 12 may continue to enter the query 14 (e.g., adding new tokens, removing tokens that are skewing the search results, or modifying or reordering existing tokens). Accordingly, a second query 14 may be identified, and the search results may be altered (e.g., by removing candidate content items 38 that do not match second query tokens that have been added to the second query 14; by adding candidate content items 38 that did not match the first query 14 but that that match the second query 14 due to the removal of one or more first query tokens) and/or reordered (e.g., by re-ranking the candidate content items 38 based on the tokens of the second query 14). A second set of search results may therefore be presented to the user 12 based on the second query 14.

This variation may allow the user to view the adjustments to the search results in near-realtime while entering the query 14; may allow the user 12 to determine how to modify the query 14 to identify intended search results (e.g., by removing query terms that are matching too many unrelated candidate content items 38); and may allow the user 12 to stop entering additional search terms when the query 14 is sufficiently focused or has identified the candidate content item 38 that the user 12 is seeking. For example, a user 12 may enter a first search query comprising a particular set of tokens (e.g., “blue 1957”), and may quickly be presented with a broad list of candidate content items 38. The user 12 may then continue entering tokens 52 comprising additional “hints” for the query 12, such as “blue 1957 car,” thereby narrowing the set of candidate content items 38 to those describing blue automobiles involved with the year 1957, and removing candidate content items 38 not relating to automobiles. The user 12 may then add another hint, such as “blue 1957 car v8,” which may automatically adjust the search results to present a null set of search results (e.g., if the user 12 is misremembering that the car in question was had a v8 engine). The user 12 may then replace the latter token 52 with the new token 52 “v6”, and the embodiment may display a small set of search results satisfying these tokens 52, which may include a candidate content item 38 that the user 12 sought. This adjusting of the candidate content items 38 in response to the inputting of the query 14 may allow the user 12 to tailor the query 14 to the desired intent of the user 12 by rapidly displaying the consequences of adding, removing, or altering various “hints” as to the candidate content items 38 matching the query 14. Those of ordinary skill in the art may devise many scenarios wherein the techniques presented herein may be utilized.

A second aspect. that may vary among embodiments of these techniques relates to the manner of indexing content items 22 according to various identifiers 42. As a first example, many pieces of data that identify the content item 22 may be utilized as identifiers 42, such as a name or title of the content item 22, a location of the content item 22 within a content set 20, a creation date, the name of a user 12 comprising an owner or creator of the content item 22, a content item type, various properties of the contents of the content item 22 (e.g., a summary or set of frequently appearing keywords in a document, or a textual description of an image), various pieces of metadata associated with the content item 22, or other content items 22 to which the content item 22 is related. Additionally, it may be desirable to index respective content items 22 according to all identifiers 42 associated therewith (and assigning at least minimal weight to each identifier 42). Conversely, an application may be selective about the identifiers 42 used to index a content item 22 in the content index 46. For example, in indexing an email message, an application may lexically identify the keywords of the title and body of the message that significantly pertain to the content of the message (such that a user 12 may search for the email message according to such keywords), but may refrain from indexing the message according to other keywords that are only tangentially related to the message (such that a user 12 is unlikely to search for the message according to the keywords). As a second example of this second aspect, the identifiers 42 may be indexed in many ways within the content index 46. For example, the identifiers 42 may be natively stored in the content index 46, may be converted to a standard data type (e.g., an alphanumeric string), or may be stored according to a condensed format (e.g., a hashcode of the identifier 42).

As a third example of this second aspect, the identifiers 42 may be indexed in various portions, in addition to being indexed as a whole identifier. For example, an identifier 42 may comprise several portions of an identifier for which a user 12 may search, such as different portions of a filename of a file (e.g., the file “David's_Report.doc” might be queried by the user 12 as “David”, “Report”, “doc”, “David's_Report”, “Report.doc”, or “David's_Report.doc”). Therefore, a particular identifier 42 for a particular content item 22 may be indexed in several different ways, based on these variances in the ways that a user 12 may search for the identifier 14 in a query 20. Moreover, different identifier weights 44 may be stored with the different identifiers 42 to indicate the relative relevance of a token 52 matching the respective identifier 42 and/or the distinctiveness of the identifier 42 in identifying the content item 22 as distinguished from other content items 22. For example, a content item 22 may be associated with a name having various name components (e.g., a first name, a middle name, a last name, and a suffix), and an embodiment of these techniques may be configured to index the content item 22 by both the name and various name components. Moreover, the different selectivity of different name components may be represented as different identifier weights 44; e.g., an identifier 42 representing a name of a content item 22 may be indexed with a high identifier weight, while name components may be indexed with low identifier weights.

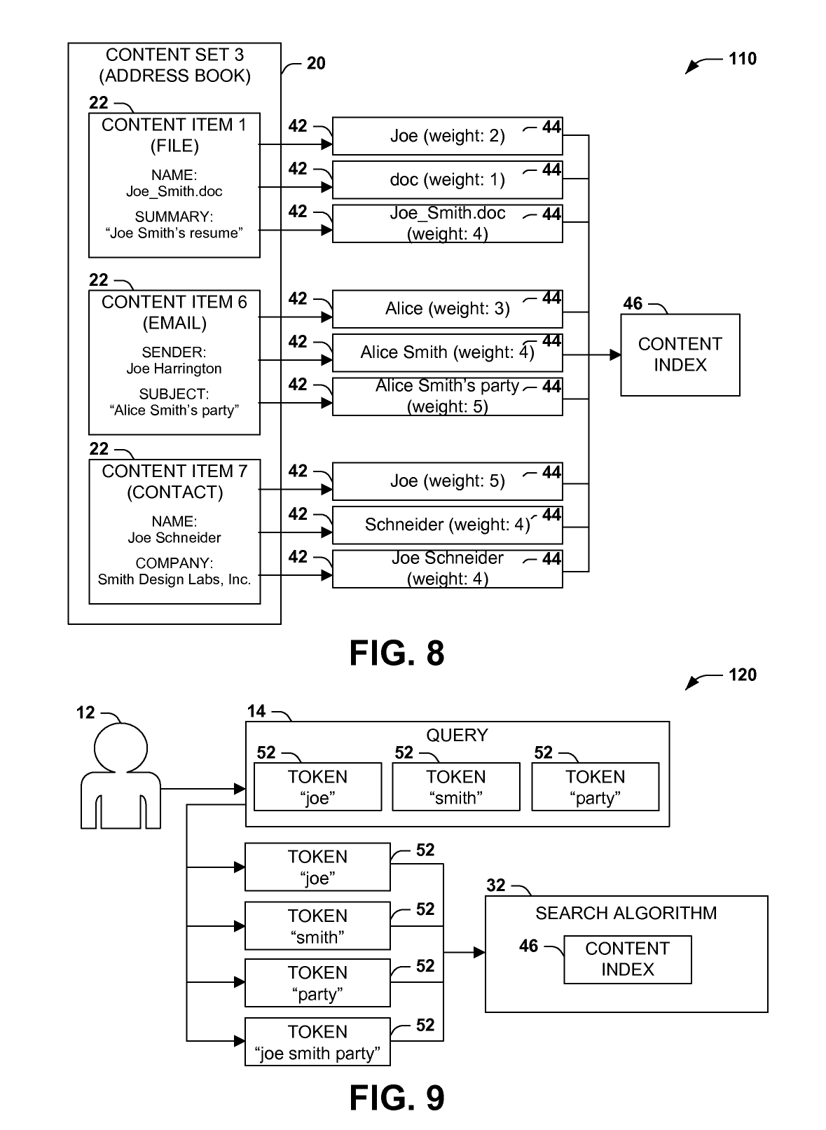

FIG. 8 presents an exemplary scenario 110 featuring a set of content items 22 of various content sets 20, for which various identifiers 42 may be extracted and stored in the content index 46 along with different identifier weights 44. In accordance with this third example of this second aspect, each content item 22 may be indexed with several identifiers 42, each of which may have a different identifier weight 44 based on the significance of an identifier 42 matched with a token 52 of a query 14. For example, a first content item 22 associated with a file having the filename “Joe_Smith.doc” may be indexed in the content index 46 by a first identifier 42 comprising the string “joe” (having a comparatively low identifier weight 44 indicative of a low significance of this small portion of the filename), a second identifier 42 comprising the string “doc” matching the extension of the file (having an even lower identifier weight 44 indicating an unlikelihood that the user 12 might search for this content item 22 by searching for its extension), and a third identifier 42 comprising the string “Joe_Smith.doc” matching the entire filename (indicating a somewhat higher likelihood of a user 12 searching for the file based on its full filename). For a second content item 22 comprising an email message with the title “Alice Smith's party”, identifiers 42 of slightly increasing identifier weight 44 may be created for “Alice”, “Alice Smith”, and “Alice Smith's party”. Similarly, for a third content item 22 comprising a contact record for an individual named Joe Schneider, identifiers 42 of increasing identifier weight 44 may be created for “Joe”, “Schneider”, and “Joe Schneider”. However, because this individual is closely known to the user 12, the identifier 42 representing the first name of the individual may be indexed with a higher identifier weight 44 than for the identifier 42 representing the last name of the individual, accounting for the fact that the user 12 more often refers to this well-known individual by first name (“Joe”) than last name (“Schneider”) or full name (“Joe Schneider”). Such different identifiers 42 may be automatically extracted, e.g., by splitting the identifier 42 using various criteria (e.g., non-letter and non-number alphanumeric characters and/or whitespace) and/or weighted, e.g., by identifying the length and/or selectivity of the extracted portion (e.g., many document-type files in the filesystem may be identified by the extension “.doc”, but only a few files may include the string “joe”, leading to a higher selectivity of this identifier 42 and a higher identifier weight 44). Those of ordinary skill in the art may devise many ways of indexing content items 22 in the content index 46 while implementing the techniques presented herein.

A third aspect that may vary among embodiments of these techniques relates to simple filtering techniques that may be implemented in conjunction with the relevance-based techniques provided herein. As a first example, a user 12 may submit a query 14 specifying a particular content item type of candidate content items 38 to be presented, such as only email messages or only contact records (e.g., the query “email joe smith” may be inferred as restricting the candidate content items 38 to only email messages). As a second example of this third aspect, the user 12 may submit a query 14 including one or more tokens 52 specifying a particular content set 30, e.g., objects in a particular filesystem or in a particular portion thereof (e.g., the query “filesystem joe smith” may be inferred as restricting the candidate content items 38 only to those stored in the local filesystem). As a third example of this third aspect, a query 14 may specify that one or more tokens 52 are to be applied only to particular identifier types (e.g., the query “name joe smith” may be inferred as restricting the candidate content items 38 only to those matching the following tokens 52 in a “name” identifier type, such as the owner of a file, the sender or recipient of an email message, or the first name and/or last name of a contact record). For example, different types of content items 22 may have different sets of identifiers 42, but some identifiers 42 may have a shared semantic (e.g., “Name”, “Title”, or “Date of Creation”) and/or a shared data format (e.g., “email address”, “date”, or “telephone number”). A token 52 of a query 14 may therefore specify that candidate content items 38 have an identifier type of a particular value (e.g., the query 14 “name joe smith” may specify content items 22 having an identifier of semantic type “Name” with a value such as “Joe Smith”; the query 14 “email joe@mail.com” may specify content items 22 having an identifier formatted as email addresses and having the value “joe@mail.com”). In this manner, various tokens 52 of the query 14 may be construed to specify various types of simple filtering that may be applied to the content items 22. Those of ordinary skill in the art may devise many ways of permitting a user 12 to apply a simple filter to a query 14 while implementing the techniques presented herein.

A fourth aspect that may vary among embodiments of these techniques relates to the manner of extracting tokens 52 from a query 14 for application to the content index 46. As a first example, the user 12 may explicitly differentiate tokens 52, e.g., by entering different tokens 52 in a sequence. Alternatively, the user 12 may delineate tokens 52 within a query 14 by various properties, e.g., by separating whitespace characters, such as a space, tab, or carriage return. Some embodiments may also permit the user 12 to specify that several sequences are to be evaluated as a single token, e.g., by enclosing a set of tokens in quotation marks or parentheses.

As a second example of this fourth aspect, an embodiment may apply the tokens 52 to the content index 46 in various ways. As a first such variation, the tokens 52 may be applied to the content index 46 in a particular order; e.g., a token 52 identified as highly selective of a small set of content items 22 (e.g., a long string or an unusual term) may be applied to the content index 46 before a token 52 identified as less selective among the content items 22 (e.g., a short string or a frequent term). As a second such variation, an embodiment may endeavor to suggest and correct possibly typographical errors (e.g., suggesting a replacement of the token 52 “patnet” for the token 52 “patent”). As a third such variation, an embodiment may apply each token 52, as well as a token 52 comprising the entire query 14. This variation may be helpful, e.g., for promoting matching with identifiers 42 that match the entire query 14 or a significant portion thereof.

FIG. 9 presents an exemplary scenario 120 illustrating an extraction of tokens 52 from a query 14 for application to a content index 46. In this exemplary scenario 120, a user 12 enters the query 14 “joe smith party”. An embodiment of these techniques may partition this query 14 by whitespace characters to extract the tokens 52 “joe”, “smith”, and “party”, each of which may be applied to the content index 46 by a search algorithm 32. Additionally, the entire query 14 may be evaluated as a single token 52 (“joe smith party”), which may rapidly identify content items 22 matching the entire phrase. In this manner, the tokens 52 of the query 14 may be extracted and applied to the content index 46. Those of ordinary skill in the art may devise many ways of extracting tokens 52 from a query 14 for application to a content index 46 while implementing the techniques presented herein.

As a third example of this fourth aspect, the application of tokens 52 to the content index 46 may be adjusted in various ways. In a first such variation, content items 22 may only be selected as candidate content items 38 only if at least one identifier 42 of the content item 22 matches each token 52 of the query 14. This variation may be advantageous for respecting that each token 52 has some semantic value to the user 12, and that a content item 22 cannot be selected as a candidate content item 38 if any token 38 is not matched to the candidate content item 38 in some way. As another variation, highly relevant content items 22 may be included as candidate content items 38 even if one or more tokens 52 of the query 14 do not match at least one identifier 42. This variation may be advantageous, e.g., if a highly relevant token happens to fail to match one or more criteria of the query 14, or if one particular token 52 matches no content items 22 (e.g., a typographical error in a token 52 that matches no identifier 42 of any content item 22 may be disregarded). Alternatively, a proximity adjustment may be calculated and used in searching the content index 46; e.g., if a token 52 such as “patnet” matches few or no identifiers 42 of the content items 22, candidate content items 38 may be selected that include one or more identifiers 42 that are proximate to the token 52, such as those containing the term “patent”.

A fifth aspect that may vary among embodiments of these techniques relates to adjustments to the rank scores 56 of candidate content items 38 in view of other criteria that may be predictiveness of the relevance of the matching of the candidate content item 38 to the query 14. In some embodiments of these techniques, after retrieving the identifiers 42 matching the tokens 52 of the query 42 and calculating a rank score 56 for the associated candidate content items 38 based on the identifier weights 44 stored with such identifiers 42, the rank scores 56 of the candidate content items 38 may be adjusted to improve the ordering of the candidate content items 38 in view of the predicted relevance thereof to the intent of the user 12 in formulating the query 14.

As a first example of this fifth aspect, the rank scores 56 of candidate content items 38 may be computed in view of a particular search context of the query 14. It may be appreciated that different queries 14 may be entered in different search contexts. For example, a first query 14 may be entered in a search control of an email client application; a second query 14 may be entered into a search control of a contacts database; and a third query 14 may be entered into a search control of a filesystem. However, it may be appreciated that the user 12 may choose different tokens of the query 14 differently in view of the search context. For example, if a user 12 enters a query 14 in the context of a name search (e.g., a search initiated in the context of a “To:” line in an email message), candidate content items 38 matching a query 14 on a name-related identifier (e.g., the Sender field of an email message or the Name field of a contact record) may be of higher predicted relevance to the user 12 than candidate content items 38 matching the query 14 on a filesystem-related identifier (e.g., a filename field). Conversely, if the user 12 enters a query 14 in a file-related search context (e.g., attaching an object to an email message), the filename field may be of higher predicted relevance. Accordingly, the search context of each query may be taken into account while inferring the intent of the user 12 and interpreting the query 14. For example, if a query 14 is provided by the user 12 in a search context associated with at least one identifier, the rank scores 56 of various candidate content items 38 may be computed by raising the identifier weights 44 of identifiers 42 matching a token 52 of the query 14 that are also associated with the search context.

As a second example of this fifth aspect, if the candidate content items 38 may be evaluated for popularity (e.g., in the context of content items 22 accessed by a user 12, the frequency with which the user 12 has accessed the content item 22 in the past; and in the context of web search results, based on the number of users clicking through a link to a particular content item 22, or the number of links to the content item 22 on other pages), the contribution of an identifier weight 44 of an identifier 42 may be adjusted based on the popularity of the candidate content item 38. For example, if the popularity of a content item 22 is associated with the likelihood of a user searching for the content item 22, the rank score 52 of the candidate content item 38 may be increased, thereby presenting popular candidate content items 38 as having a higher predicted relevance to the user 12 than similarly weighted but unpopular candidate content items 38.

As a third example of this fifth aspect, the contribution of an identifier weight 44 of an identifier 42 to the rank score 56 of a candidate content item 38 may be increased if a token 52 matches multiple identifier portions of the identifier 42. For example, if the query 14 comprises a particular token 52, an identifier 42 having several instances of this token 52 may be regarded as having a higher predictive relevance than an identifier 42 having fewer or only one instance of this token 52. Accordingly, while calculating the rank scores 56 of respective candidate content items 38, an embodiment of these techniques may be configured to raise the identifier weights 44 of identifiers 42 matching more than one token 52 of the query 14.

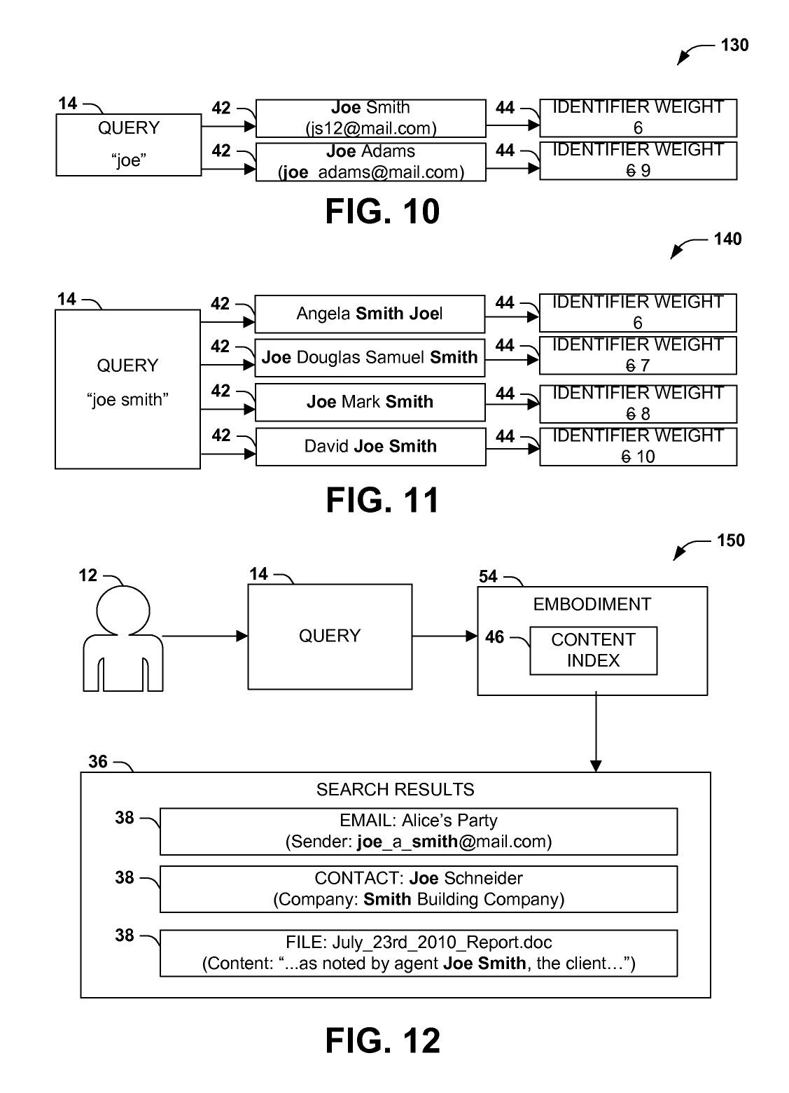

FIG. 10 presents an illustration of an exemplary scenario 130 featuring the adjustment of a rank score 56 of a candidate content item 38 according to this third example of this fifth aspect. In this exemplary scenario 130, a query 14 is submitted comprising the token 52 “joe”, and is matched to two identifiers 42 for two different candidate content items 38, each having an initial identifier weight 44 of six. However, the token 52 of the query 14 matches the first identifier 42 (“Joe Smith”, having an email address of “js12@mail.com”) in only one identifier portion (as illustrated in bold), but matches the second identifier 42 (“Joe Adams”, having an email address of “joe_adams@mail.com”) in two identifier portions. Accordingly, the rank score 56 of the second identifier 42 may be increased for inclusion in the rank score 56 of the second candidate content item 38, indicating a higher predicted relevance of the second candidate content item 38 to the intent of the query 14.

As a fourth example of this fifth aspect, a query 14 having multiple tokens 52 specified as a sequence, but that may together match various identifier portions of a particular identifier 42. It may be appreciated that the sequence whereby a user 12 enters tokens 52 in a query 14 may be significant, and that sequential conformity of the identifier portions of identifiers 42 matching the sequence of the tokens 52 may be predictive of the relevance of the associated candidate content item 38 with the intent of the query 14. Accordingly, in this fourth example, the identifier weight 44 of the identifier 42 may be raised if the tokens 52 match the identifier portions in approximately the same sequence. For example, if a second token 52 sequentially follows a first token 52 in the query, the identifier weight 44 of an identifier 42 may be increased if the first token 52 matches a first identifier portion of the identifier 42, and the second token 52 matches a second identifier portion of the identifier 42 that sequentially follows the first identifier portion. In a first such variation, the identifier weight 44 may also be increased in proportion to a proximity of the second identifier portion of the identifier 42 with the first identifier portion; e.g., the magnitude by which the identifier weight 44 is raised increases as the tokens 52 match identifier portions that are closer together within the identifier. In a second such variation, the identifier weight 44 may be particularly strongly increased if the second identifier portion directly sequentially follows the first identifier portion, e.g., if the first token 52 and the second token 52 match with a sequence of directly following identifier portions in the identifier 42, such as a phrase. Additional increases in the rank scores 56 may be made if additional tokens 56 also match according to the sequence of identifier portions in an identifier 42, e.g., four tokens matching four directly sequential identifier portions of a candidate content item 38.

FIG. 11 presents an exemplary scenario 140 featuring an adjustment of rank scores 56 of various candidate content items 38 in accordance with this fourth example of this fifth aspect. In this exemplary scenario 140, the query 14 comprises the tokens “joe” and “smith”, and matches four identifiers 42 associated with four candidate content items 38, comprising four different names of four different individuals specified in four different contact records in an address book. However, the sequence of the tokens 52 matching the identifier portions of the respective identifiers 42 may be utilized to adjust the rank scores 56 of the candidate content items 38 to improve the relevance of the matches with the intent of the query 14. As a first example, the tokens 52 match a first identifier 42 (“Angela Smith Joe”) in two identifier portions, but in the reverse sequential order (first “smith”, then “joe”), while the tokens 52 match a second identifier 42 (“Joe Douglas Samuel Smith”) in the correct sequential order (a first identifier portion “joe”, sequentially followed, after a significant identifier portion, by a second identifier portion “smith”). Accordingly, the identifier weight 44 of the second identifier 42 may be calculated into the rank score 56 of the corresponding candidate content item 38 with an upward adjustment as compared with the second identifier 42 (e.g., an identifier weight 44 of seven instead of six). As a second example, a third identifier 42 (“Joe Mark Smith”) may similarly match the tokens 52 in identifier portions having a correct sequential order, but, in contrast with the second identifier 42, may have a smaller intervening portion of the identifier 42 (e.g., one four-letter word vs. two words comprising thirteen letters). Accordingly, the identifier weight 44 of the third identifier 42 may calculated into the rank score 56 of the corresponding third candidate content item 38 with a higher value than the identifier weight 44 of the second identifier 42 for the second candidate content item 38 (e.g., an identifier weight 44 of eight). As a third example, a fourth identifier 42 (“David Joe Smith”) may feature identifier portions that directly sequentially match the sequence of tokens 52 in the query 14, and may therefore be calculated into the rank score 56 of the corresponding candidate content item 38 with a strongly increased value of ten. Such adjustments to the rank scores 56 of the candidate content items 38 based on the sequence of matched identifier portions of an identifier 42 with the sequence of tokens 52 in the query 14 may improve the relevance of the presented search results 36 to the intent of the user 12.

As a fifth example of this fifth aspect, the rank score 56 of a candidate content item 38 may be strongly increased if the identifier 22 fully matches the query 14. For example, a query 14 comprising the tokens 52 “joe smith” may result in the calculation of a strongly increased rank score 56 for a contact record having the name “Joe Smith”. This adjustment may satisfy the intent of a user 12 who happens to enter the full and exact contents of an identifier 42 associated with a candidate content item 38.

As a sixth example of this fifth aspect, a rank score 56 of an identifier 42 may be increased based on a percentage of an identifier portion of an identifier 42 matching the token 52. For example, for a query 14 comprising a token 52 having three characters (e.g., “Kat”), the identifier weight 44 of a first identifier 42 matching the three characters of the token 52 and having an overall length of four characters (e.g., “Kate”), where 75% of the identifier 42 matches the token 52, may be factored into the rank score 56 of the corresponding candidate content item 38 with a higher adjustment than a second identifier 42 matching the three characters of the token 52 but having an overall length of nine characters (e.g., “Katherine”), where only 33% of the identifier 42 matches the token 52.

As a seventh example of this fifth aspect, the rank score 56 of a candidate content item 38 may be increased based on the distinctiveness of the matched identifier 38 with the candidate content item 38 among the content items 22 of the content sets 20; e.g., a comparatively infrequent token 56 that matches a candidate content item 38 may have an adjusted higher identifier weight 44 than a comparatively frequent token 56 that matches the candidate content item 38 but also many other content items 22. Accordingly, the identifier weight 44 of an identifier 42 may be raised inversely to the content item count of content items 22 matching the token 52. For example, for a query 14 comprising the tokens 52 “joe” and “arrington”, the token 52 “joe” may match many content items 22, but the token “arrington” may match only a few content items 22, and may therefore be comparatively highly selective of candidate content items 38. Accordingly, an embodiment of these techniques may raise the rank score 56 of a candidate content items 38 matching the token “arrington” to reflect the selectivity of this matching, as compared with the comparatively less selective matching with the token 52 “joe”. Those of ordinary skill in the art may devise many ways of adjusting the rank scores 56 of candidate content items 38 to improve the predicted relevance of the search results 36 to the intent of the user 12 in formulating the query 14 in accordance with the techniques presented herein.

A sixth aspect that may vary among embodiments of these techniques relates to the presentation to the user 12 of the candidate content items 38 as a set of search results 36 in response to the query 14. As a first example of this sixth aspect, the candidate content items 38 may be simply identified (e.g., as a list of files), may be linked (e.g., as a set of hyperlinks or icon-based shortcuts) for easy access, may be presented as previews (e.g., a set of thumbnails or text excerpts of documents), and/or may be presented to the user 12 (e.g., as a slideshow of images matching the query 14). As a second example of this sixth aspect, the candidate content items 38 are presented sorted according to the rank scores 56, but may also be sorted according to other criteria. In one such variation, where candidate content items 38 have a name, the candidate content items 38 may first be sorted by a name length of the names, and may then be stably sorted according to the rank scores 56. As a third example of this sixth aspect, the candidate content items 56 may be presented along with the identifiers 42 matching the tokens 52 of the query 14. This example may be advantageous, e.g., for presenting to the user 12 some of the rationale for presenting respective content items 22 in the search results 36, particularly for content items 22 where such rationale may not be readily apparent from the other presented information (e.g., it may be unclear why a candidate content item 38 named “Report.doc” is included in the search results 36 for a query 14 comprising the tokens 52 “joe smith”, so the identifiers 42 matching the tokens 52 of the query 14, such as an Author metadata field specifying the name “Joe Smith” or a phrase containing this name embedded in the document, may be presented along with the candidate content item 36). Additionally, the identifier portions of the identifiers 42 that matched the respective tokens 52 of the query 14 may be emphasized in the presentation of candidate content items 38, e.g., by presenting the matched identifier portions in bolded typeface.

FIG. 12 presents an exemplary scenario 150 featuring a presentation of search results 36 comprising candidate content items 38 matched in response to a query 14. In this exemplary scenario 150, a user 12 may submit a query 14 comprising various tokens 52, and the query 14 may be evaluated by an embodiment 54 of these techniques, utilizing a content index 46 that indexes content items 22 of various content sets 20 according to various identifiers 42 having an identifier weight 44. The candidate content items 38 may then be presented as search results 36 sorted according to the respective rank scores 58, but may also be presented with some additional variations that may be helpful to the user 12. As a first example, the candidate content items 38 may be sorted according to a distinctive trait such as a name, and may be sorted in various ways (e.g., alphabetically and/or according to a name length). As a second example, the identifiers 42 matching the tokens 52 of the query 14 may be presented, and the identifier portions matching the tokens 52 may be emphasized, e.g., through the use of a bolded typeface. In this manner, the search results 36 may be presented in a manner that is relevant to the query 14, and that indicates the correlation of the candidate content items 38 with the tokens 58 of the query 14. Those of ordinary skill in the art may devise many ways of presenting candidate content items 38 in response to a query 14 while implementing the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

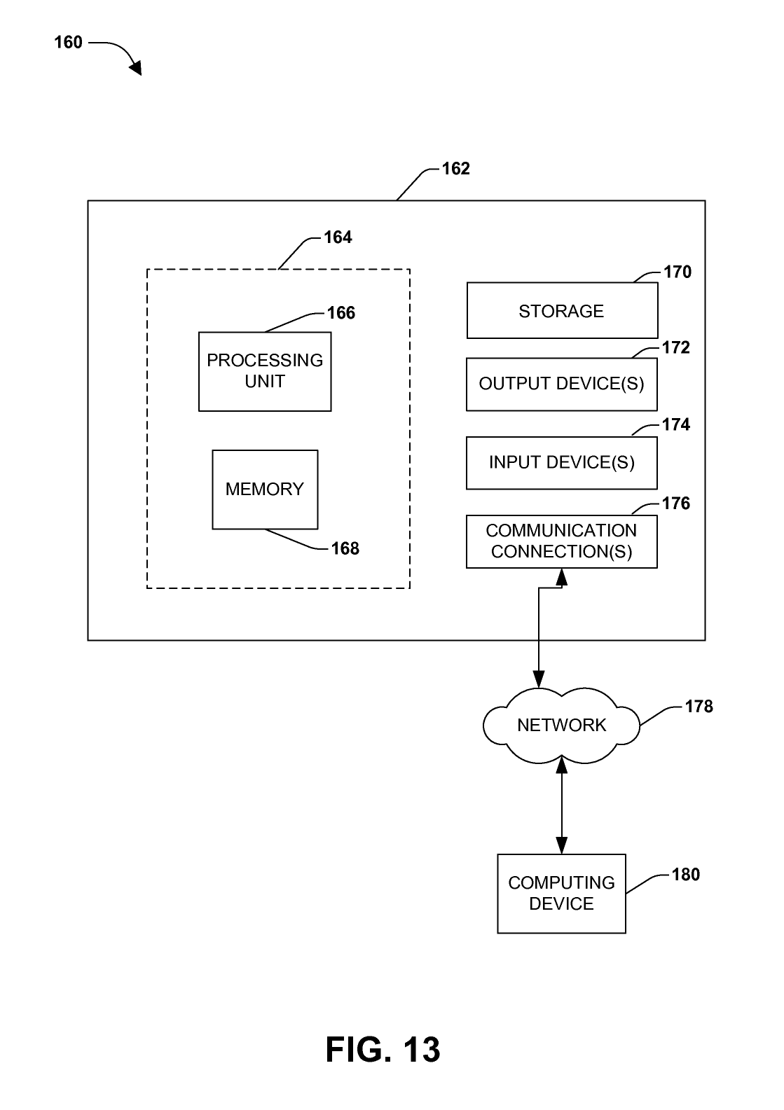

FIG. 13 and the following discussion provide a brief, general description of a suitable computing environment to implement embodiments of one or more of the provisions set forth herein. The operating environment of FIG. 13 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 13 illustrates an example of a system 160 comprising a computing device 162 configured to implement one or more embodiments provided herein. In one configuration, computing device 162 includes at least one processing unit 166 and memory 168. Depending on the exact configuration and type of computing device, memory 168 may be volatile (such as RAM, for example), non-volatile (such as ROM, flash memory, etc., for example) or some combination of the two. This configuration is illustrated in FIG. 13 by dashed line 164.

In other embodiments, device 162 may include additional features and/or functionality. For example, device 162 may also include additional storage (e.g., removable and/or non-removable) including, but not limited to, magnetic storage, optical storage, and the like. Such additional storage is illustrated in FIG. 13 by storage 170. In one embodiment, computer readable instructions to implement one or more embodiments provided herein may be in storage 170. Storage 170 may also store other computer readable instructions to implement an operating system, an application program, and the like. Computer readable instructions may be loaded in memory 168 for execution by processing unit 166, for example.

The term “computer readable media” as used herein includes computer storage media. Computer storage media includes volatile and nonvolatile, removable and non-removable media implemented in any method or technology for storage of information such as computer readable instructions or other data. Memory 168 and storage 170 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 162. Any such computer storage media may be part of device 162.

Device 162 may also include communication connection(s) 176 that allows device 162 to communicate with other devices. Communication connection(s) 176 may include, but is not limited to, a modem, a Network Interface Card (NIC), an integrated network interface, a radio frequency transmitter/receiver, an infrared port, a USB connection, or other interfaces for connecting computing device 162 to other computing devices. Communication connection(s) 176 may include a wired connection or a wireless connection. Communication connection(s) 176 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 162 may include input device(s) 174 such as keyboard, mouse, pen, voice input device, touch input device, infrared cameras, video input devices, and/or any other input device. Output device(s) 172 such as one or more displays, speakers, printers, and/or any other output device may also be included in device 162. Input device(s) 174 and output device(s) 172 may be connected to device 162 via a wired connection, wireless connection, or any combination thereof. In one embodiment, an input device or an output device from another computing device may be used as input device(s) 174 or output device(s) 172 for computing device 162.

Components of computing device 162 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 162 may be interconnected by a network. For example, memory 168 may be comprised of multiple physical memory units located in different physical locations interconnected by a network.

Those skilled in the art will realize that storage devices utilized to store computer readable instructions may be distributed across a network. For example, a computing device 180 accessible via network 178 may store computer readable instructions to implement one or more embodiments provided herein. Computing device 162 may access computing device 180 and download a part or all of the computer readable instructions for execution. Alternatively, computing device 162 may download pieces of the computer readable instructions, as needed, or some instructions may be executed at computing device 162 and some at computing device 180.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of evaluating queries comprising at least one token against at least one content set respectively comprising at least one content item respectively having at least one identifier on a device having a processor and a content index, comprising:
executing on the processor instructions configured to:
for respective content items, index the content item in the content index according to at least one identifier having an identifier weight; and
upon receiving a query:
identify candidate content items indexed in the content index by, for respective tokens of the query, at least an identifier portion of an identifier matching the token;
for respective candidate content items, calculate a rank score according to the identifier weights of the identifiers matching the tokens of the query; and
present the candidate content items sorted according to the rank scores.

2. The method of claim 1:
the query provided in a search context associated with at least one identifier; and
calculating the rank score comprising: for respective candidate content items, raising the identifier weights of identifiers of candidate content items matching at least one token of the query and associated with the search context.

3. The method of claim 1, calculating the rank score comprising: raising the rank scores of popular candidate content items.

4. The method of claim 1, comprising:
upon receiving a second query related to the query:
remove from the candidate content items at least zero removed candidate content items that, for at least one second query token included in the second query and not included in the query, are not indexed by at least one identifier portion matching the second query token;
insert into the candidate content items at least zero added candidate content items that are indexed in the content index by, for respective tokens of the second query, at least an identifier portion of an identifier matching the token, and that, for at least one first query token included in the query and not included in the second query, are not indexed by at least one identifier portion matching the first query token;
for respective candidate content items, calculate a second rank score according to the identifier weights of the identifiers matching the tokens of the second query; and
present the candidate content items sorted according to the second rank scores.

5. The method of claim 1:
the at least one content set comprising a locally stored content item set comprising content items of a content item type;
the content item type of at least one content item comprising a custom item type associated with an application; and
the instructions configured to, upon receiving from the application a request to index a content item of the custom item type according to at least one custom identifier, index the content item in the content index according to at least one custom identifier.

6. The method of claim 1:
a content item comprising a name having at least one name component; and
the instructions configured to index the content item in the content index according to:
the name of the content item, and
respective name components of the name of the content item.

7. The method of claim 6, the instructions configured to:
index the name of the content item as an identifier having a high identifier weight; and
match respective name components of the name of the content item with a low identifier weight that is lower than the high identifier weight of the name of the content item.

8. The method of claim 1:
identifying the candidate content items comprising:
for respective tokens of the query, identify candidate content items indexed in the content index by at least an identifier portion of an identifier matching the token;
for the query, identify candidate content items indexed in the content index by at least an identifier portion of an identifier matching the token; and
calculating the rank scores comprising: for respective candidate content items, adding the identifier weights of the identifiers matching the respective tokens of the query and the query.

9. The method of claim 1:
the instructions configured to sort the candidate content items according to a name length of a name of the respective candidate content items; and
presenting the candidate content items comprising: presenting the candidate content items stably sorted according to the rank scores after sorting the candidate content items according to the name length of the names of the respective content items.

10. The method of claim 1, presenting the candidate content items comprising: presenting with respective candidate content items the identifiers matching the tokens of the query.

11. The method of claim 10, presenting the candidate content items comprising: emphasizing identifier portions of the identifiers of the candidate content items matching the tokens of the query.

12. The method of claim 1, calculating the rank score of a candidate content item comprising: raising the identifier weights of identifiers matching more than one token of the query.

13. The method of claim 1:
at least one content item identified by a first identifier portion sequentially followed by a second identifier portion;
the query comprising a first token sequentially followed by a second token; and
calculating the rank score of a candidate content item comprising: raising the identifier weights of identifiers having a second identifier portion sequentially following the first identifier portion and matching the second token sequentially following the first token matching the first identifier portion.

14. The method of claim 13, raising the identifier weight of the identifiers comprising: raising the identifier weights of identifiers having a second identifier portion directly sequentially following the first identifier portion and matching the second token directly sequentially following the first token matching the first identifier portion.

15. The method of claim 13, raising the identifier weight of the identifiers comprising: raising the identifier weights of identifiers having a second identifier portion sequentially following the first identifier portion and matching the second token sequentially following the first token proportional to a proximity of the second identifier portion with the first identifier portion.

16. The method of claim 1, calculating the rank score of a candidate content item comprising: raising the identifier weights of identifiers fully matching the query.

17. The method of claim 1, calculating the rank score of a candidate content item comprising: raising the identifier weights of identifiers matching a token proportionally to a percentage of an identifier portion of the identifier matched by the token.

18. The method of claim 1, calculating the rank score of a candidate content item comprising: raising the identifier weights of identifiers matching a token inversely proportionally to a content item count of content items having at least one identifier matching the token.

19. A system configured to evaluate queries comprising at least one token against at least one content set respectively comprising at least one content item respectively having at least one identifier on a device having a content index, the system comprising:
a content item indexing component configured to, for respective content items, index the content item in the content index according to at least one identifier having an identifier weight;
a content item evaluating component configured to, upon receiving a query:
identify candidate content items indexed in the content index by, for respective tokens of the query, at least an identifier portion of an identifier matching the token, and
for respective candidate content items, calculate a rank score according to the identifier weights of the identifiers matching the tokens of the query; and
a search result presenting component configured to, in response to the query, present the candidate content items sorted according to the rank scores.

20. A computer-readable storage medium comprising instructions that, when executed on a processor of a device having a memory component storing a content index, evaluate queries comprising at least one token against at least one locally stored content set respectively comprising at least one content item of a content item type and having at least one identifier including a name having at least one name component, at least one content item having a custom content item type associated with an application, by:
for respective content items:
indexing the content item in the content index according to the name having a high identifier weight;
indexing the content item in the content index according to at least one name component having a low identifier weight that is lower than the high identifier weight of the name of the content item;
indexing the content item in the content index according to at least one identifier having an identifier weight; and
if the content item was received from an application with a request to index a content item of the custom item type according to at least one custom identifier, indexing the content item in the content index according to at least one custom identifier;
upon receiving a query in a search context associated with at least one identifier:
identifying candidate content items indexed in the content index by:
for respective tokens of the query, identify candidate content items indexed in the content index by at least an identifier portion of an identifier matching the token; and
for the query, identify candidate content items indexed in the content index by at least an identifier portion of an identifier matching the token;
for respective candidate content items, calculating a rank score according to the identifier weights of the identifiers matching the tokens of the query by:
adding the identifier weights of the identifiers matching the respective tokens of the query and the query;
raising the identifier weights of identifiers matching more than one token of the query;
raising the identifier weights of identifiers having a second identifier portion sequentially following a first identifier portion and matching a second token sequentially following a first token in the query and matching the first identifier portion by:
raising the identifier weights of identifiers having a second identifier portion directly sequentially following the first identifier portion and matching the second token directly sequentially following the first token matching the first identifier portion; and
raising the identifier weights of identifiers having a second identifier portion sequentially following the first identifier portion and matching the second token sequentially following the first token proportional to a proximity of the second identifier portion with the first identifier portion;
raising the identifier weights of identifiers fully matching the query;
raising the identifier weights of identifiers matching a token proportionally to a percentage of an identifier portion of the identifier matched by the token;
raising the identifier weights of identifiers matching a token inversely proportionally to a content item count of content items having at least one identifier matching the token;
raising the identifier weights of identifiers of candidate content items matching at least one token of the query and associated with the search context; and
raising the rank scores of popular candidate content items;
presenting the candidate content items by:
sorting the candidate content items according to a name length of a name;
stably sorting the candidate content items according to the rank scores; and
presenting the candidate content items with respective identifiers matching the tokens of the query and emphasizing identifier portions of the identifiers of the candidate content items matching the tokens of the query; and
upon receiving a second query related to the query:
remove from the candidate content items at least zero removed candidate content items that, for at least one second query token included in the second query and not included in the query, are not indexed by at least one identifier portion matching the second query token;
insert into the candidate content items at least zero added candidate content items that are indexed in the content index by, for respective tokens of the second query, at least an identifier portion of an identifier matching the token, and that, for at least one first query token included in the query and not included in the second query, are not indexed by at least one identifier portion matching the first query token;
for respective candidate content items, calculate a second rank score according to the identifier weights of the identifiers matching the tokens of the second query; and
present the candidate content items sorted according to the second rank scores.
